(19) United States
(12) Patent Application Publication
(10) Pub. No.: US 2015/0348112 A1
(43) Pub. Date: Dec. 3, 2015

(54) Providing Advertisements to Autonomous Vehicles

(71) Applicant: Madhusoodhan Ramanujam, Salt Lake City, UT (US)

(72) Inventor: Madhusoodhan Ramanujam, Salt Lake City, UT (US)

(21) Appl. No.: 14/824,089

(22) Filed: Aug. 12, 2015

(51) Int. Cl. G06Q 30/02; G01C 21/34

(52) U.S. Cl. CPC G06Q 30/0266; G01C 21/34

(57) ABSTRACT

Technology is described for providing advertisements to an autonomous vehicle. A starting location and a destination for the autonomous vehicle may be received. A route for the autonomous vehicle to drive from the starting location to the destination may be generated. The route may be in proximity to one or more business entities that provide a product or service of interest to a passenger within the autonomous vehicle. The route may be sent to the autonomous vehicle. The autonomous vehicle may be configured to provide commands to drive the autonomous vehicle to the destination according to the route. Advertisements may be selected for the one or more business entities in proximity to the route. The advertisements for the business entities may be transmitted when the autonomous vehicle is within a defined distance from the business entities when driving on the route to the destination.

### BACKGROUND

Autonomous vehicles, such as self-driving cars, may operate with minimal or substantially no human input. For example, a passenger may enter a destination at a console of the autonomous vehicle, such as a touch screen, and the autonomous vehicle may navigate itself to the destination (e.g., a movie theater) by sensing its surrounding environment. The autonomous vehicle may sense its surroundings using a combination of sensors, cameras, radar, light detection and ranging (LIDAR), global positioning system (GPS), etc.

Autonomous vehicles offer a large number of benefits as compared to traditional automobiles. For example, autonomous vehicles may reduce traffic collisions due to the autonomous vehicle's increased reliability and improved reaction time as compared to human drivers. Autonomous vehicles may increase roadway capacity and reduce traffic congestion. In addition, passengers that are under age, elderly, disabled, intoxicated, or otherwise impaired may benefit from traveling in autonomous vehicles.

### BRIEF DESCRIPTION OF THE DRAWINGS

FIG. 1 illustrates an autonomous vehicle in communication with a server according to an example of the present technology.

FIG. 2 is an illustration of a networked system for providing advertisements to an autonomous vehicle according to an example of the present technology.

FIG. 3 illustrates a system and related operations for providing advertisements to an autonomous vehicle according to an example of the present technology.

FIG. 4 illustrates another system and related operations for providing advertisements to an autonomous vehicle according to an example of the present technology.

FIG. 5 illustrates a system and related operations for providing additional advertisements when a route is modified for an autonomous vehicle according to an example of the present technology.

FIG. 6 is a flowchart of a method for providing advertisements to an autonomous vehicle according to an example of the present technology.

FIG. 7 depicts functionality of an autonomous vehicle operable to receive advertisements according to an example of the present technology.

FIG. 8 depicts functionality of a system for providing advertisements to an autonomous vehicle according to an example of the present technology.

FIG. 9 illustrates an autonomous vehicle according to an example of the present technology.

FIG. 10 is a block diagram that provides an example illustration of a computing device that may be employed in the present technology.

### DETAILED DESCRIPTION

Technology is described for providing advertisements to an autonomous vehicle. One example of an autonomous vehicle is a self-driving car or a driverless car. The advertisements may be transmitted from a server to the autonomous vehicle for display while the autonomous vehicle is traveling to a destination. The server may receive a starting location and the destination for the autonomous vehicle. The server may generate a route for the autonomous vehicle to drive from the starting location to the destination. The server may generate the route such that the route is in proximity to one or more entities that provide a product or service of interest to a passenger within the autonomous vehicle. The server may send the route to the autonomous vehicle. The autonomous vehicle may drive the autonomous vehicle to the destination according to the route. The server may select one or more advertisements for the one or more entities in proximity to the route. The server may transmit the advertisements for the entities when the autonomous vehicle is within a defined distance from the entities when driving along the route to the destination.

In one example, the destination may be provided from the user to the autonomous vehicle via a user interface. The destination may include a name of a business (e.g., a restaurant, bank), geographical coordinates, an address, etc. In addition, the autonomous vehicle may determine the starting location, such as a current location of the autonomous vehicle. The autonomous vehicle may send the starting location and the destination to the server. The server may be associated with an advertisement provider or an advertisement exchange platform.

In one example, the server may generate the route for the autonomous vehicle to travel from the starting location and the destination. The route may be in proximity to one or more entities (e.g., business entities) that provide products or services of interest to the passenger within the autonomous vehicle. The entities may be related to businesses (e.g., restaurants, coffee shops, and pizza places), organizations, churches, parks, libraries, etc. In one example, the server may generate the route based on the passenger's interest profile. The interest profile may include demographical information, a browsing history, a search history, a purchase history, etc. for the passenger. In other words, the interest profile may indicate products or services that are of interest to the passenger. The server may identify entities that provide the products or services of interest to the passenger, as indicated by the interest profile, and then generate the route from the starting location to the destination to be in proximity to these entities. In addition, the server may generate the route to be within a predefined threshold of a shortest-distance route and/or a shortest-time route between the starting location and the destination.

The server may generate or select the route to be taken by the autonomous vehicle, and then provide the route to the autonomous vehicle. The autonomous vehicle may drive from the starting location to the destination using the route received from the server. In particular, one or more processors of the autonomous vehicle may provide commands to the autonomous vehicle's actuators, thereby controlling steering, acceleration, braking and throttle of the autonomous vehicle.

In one example, the server may select one or more advertisements for the identified entities that are located in proximity to the route from the starting location to the destination. In other words, the server may select advertisements for the products or services provided by the entities located in proximity to the route, wherein the products or services are of interest to the passenger, as indicated in the interest profile. In addition, the advertisements may include promotional information or coupons for the entities that provide products or services of interest to the passenger within the autonomous vehicle.

In one example, the entity may be charged an advertisement fee each time their advertisement is provided to the autonomous vehicle. In other words, the entity may provide compensation for the server generating the route to be in proximity to the entity, which allows the entity's advertisement to be provided to the customer.

In one example, the server may select the advertisements based on a time of day. For example, the server may identify three business entities that are located in proximity to the autonomous vehicle's route, wherein the three business entities include a coffee shop, a restaurant, and a shopping mall. If the customer is traveling in the morning, the server may transmit an advertisement for the coffee shop. However, if the customer is traveling in the evening, the server may transmit an advertisement for the restaurant.

As the autonomous vehicle travels on the route to the destination, the server may transmit the selected advertisements to the autonomous vehicle. In one example, the server may transmit the advertisement for the entity when the autonomous vehicle is within a defined distance from the entity when driving along the route to the destination. For example, the server may track the autonomous vehicle's location as the autonomous vehicle drives on the route to the destination. If the server detects that the autonomous vehicle is approaching the entity along the route that provides products or services of interest to the passenger, the server may transmit the advertisement related to the entity for display in the autonomous vehicle.

As a non-limiting example, the server may determine that the passenger likes Indian food based on the interest profile. The server may generate the route such that the autonomous vehicle drives by an Indian restaurant while traveling to the destination. The autonomous vehicle may receive the route from the server, and then drive to the destination in accordance with the route. The server may detect when the autonomous vehicle is two minutes away from the Indian restaurant when driving on the route, and then send an advertisement for the Indian restaurant to the autonomous vehicle.

As a non-limiting example, the autonomous vehicle may be traveling from the passenger's home to the grocery store. The shortest route between the user's home and the grocery store may be four miles. The server may identify a potential route that involves driving by a farmer's market, which is of interest to the user, on the way to the grocery store. The route that involves driving by the farmer's market may be an additional mile. If the additional distance of one mile is within the predefined threshold of the shortest-distance route, then the server may generate the route such that the autonomous vehicle drives by the farmer's market. In addition, the server may transmit an advertisement for the farmer's market when the autonomous vehicle is approaching the farmer's market when driving along the route to the grocery store.

In one configuration, the server may identify a set of potential routes or candidate routes for the autonomous vehicle to take when traveling from the starting location to the destination. The potential routes in the set may be substantially the same in terms of distance and drive time. In addition, the potential routes in the set may be within the predefined threshold of the shortest-distance route and/or the shortest-time route between the starting location and the destination. As an example, a first route may allow the server to provide an advertisement for a first entity, the second route may allow the server to provide an advertisement for a second entity, and the third route may allow the server to provide an advertisement for a third entity. Each of the entities may place a bid to provide their respective advertisement to the customer when the autonomous vehicle drives to the destination. In one example, the server may select the route based on the highest bid received from the three entities. For example, if the second entity places the highest bid as compared to the other two entities, the server may send the second route to the autonomous vehicle, and the autonomous vehicle may drive to the destination in accordance with the second route. In addition, the server may send the advertisement for the second entity to the autonomous vehicle.

In an alternative configuration, the autonomous vehicle may select the route to travel from the starting location to the destination, as opposed to the server. The route may be optimized to limit a distance traveled between the starting location and the destination. In addition, the route may be optimized to limit an amount of time to travel between the starting location and the destination. In one example, the autonomous vehicle may use real-time traffic information when selecting the route, thereby reducing the amount of time to travel between the starting location and the destination.

The autonomous vehicle may send the route to the server. The autonomous vehicle may send the route prior to leaving the starting location or after the autonomous vehicle has started driving along the route to the destination. In addition, the autonomous vehicle may provide its current location to the server, thereby enabling the server to determine the autonomous vehicle's current location on the route to the destination.

In one example, the server may identify an entity (e.g., a business entity) that is located in proximity to the autonomous vehicle's route, wherein the entity provides products or services of interest to the passenger within the autonomous vehicle. The server may identify the products or services that interest the passenger based on the passenger's interest profile. The server may select an advertisement for the entity that is located in proximity to the autonomous vehicle's route. In other words, the server may select the advertisement for the products or services of interest to the passenger within the autonomous vehicle. In addition, the server may track the autonomous vehicle's position on the route, such that the server may transmit the advertisement to the autonomous vehicle when the autonomous vehicle is within a defined distance from the entity when driving along the route to the destination.

In one example, the server may select the advertisement based on a bidding auction between at least two entities that are located in proximity to the autonomous vehicle's route, wherein the server may select the advertisement associated with the entity that wins the bidding auction. In other words, the advertisement associated with the entity that wins the bidding auction may be provided to the autonomous vehicle.

As a non-limiting example, the server may identify a coffee shop, a restaurant, and a shopping mall that are in proximity to the autonomous vehicle's route. The coffee shop, restaurant and shopping may each submit bids to provide their respective advertisement to the customer in the autonomous vehicle in a bidding process. As an example, if the coffee shop wins the bid, then an advertisement for the coffee shop may be transmitted to the autonomous vehicle. For example, the advertisement for the coffee shop may be transmitted when the autonomous vehicle is one mile away from the coffee shop when driving along the route to the destination.

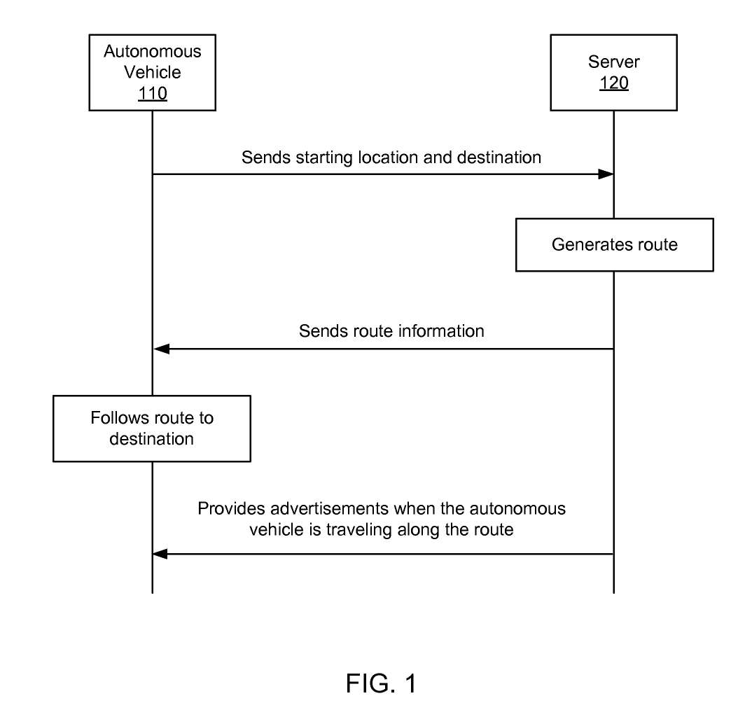

FIG. 1 illustrates an exemplary system and related operations for providing advertisements from a server 120 to an autonomous vehicle 110. The server 120 may be associated with an advertisement provider or an advertisement exchange platform. In one example, the autonomous vehicle 110 may drive from a starting location to a destination in accordance with a route. The server 120 may provide advertisements for business entities (e.g., restaurants, massage centers) that are located in proximity to the route as the autonomous vehicle 110 is driving from the starting location to the destination.

In one example, the autonomous vehicle 110 may be instructed (e.g., by a user) to travel from the starting location to the destination. The autonomous vehicle 110 may send the starting location and the destination to the server 120. The server 120 may generate the route for the autonomous vehicle 110 to drive from the starting location to the destination. The server 120 may generate the route to be in proximity to a business entity (e.g., a pizza place) that is of potential interest to the user riding in the autonomous vehicle 110. In other words, the server 120 may generate the route such that the autonomous vehicle 110 drives by the business entity that is of potential interest to the user. The business entity may provide products or services that are of interest to the user, as indicated in a user profile. In addition, the server 120 may generate the route to be within a predefined threshold of a shortest-distance route and/or a shortest-time route between the starting location and the destination.

The server 120 may send the route to the autonomous vehicle 110. The autonomous vehicle 110 may drive to the destination using the route received from the server 120. The server 120 may identify an advertisement for the business entity that is located in proximity to the route. In one example, the advertisement may be for products or services offered by the business entity, which are of interest to the user. When the autonomous vehicle 100 is relatively close to the business entity of interest (e.g., 3 minutes away from the pizza place) when driving along the route to the destination, the server 120 may send the advertisement (e.g., a pizza advertisement) to the autonomous vehicle 110. The advertisement may be displayed on a display screen inside the autonomous vehicle 110. In one example, the user in the autonomous vehicle 110 may view the advertisement and direct the autonomous vehicle 110 to digress from the route and stop at the business entity, or alternatively, the user may ignore the advertisement and the autonomous vehicle 110 may continue along the route to the destination.

The present technology enables business entities to provide targeted advertisements to a plurality of users. The targeted advertisements may entice users to stop at the business entity in order to purchase products or services that are potentially of interest to the user. Furthermore, by providing targeted advertisements for business entities that are along the autonomous vehicle's route, the user may not be inconvenienced by driving a relatively far distance off the route in order to visit the business entity.

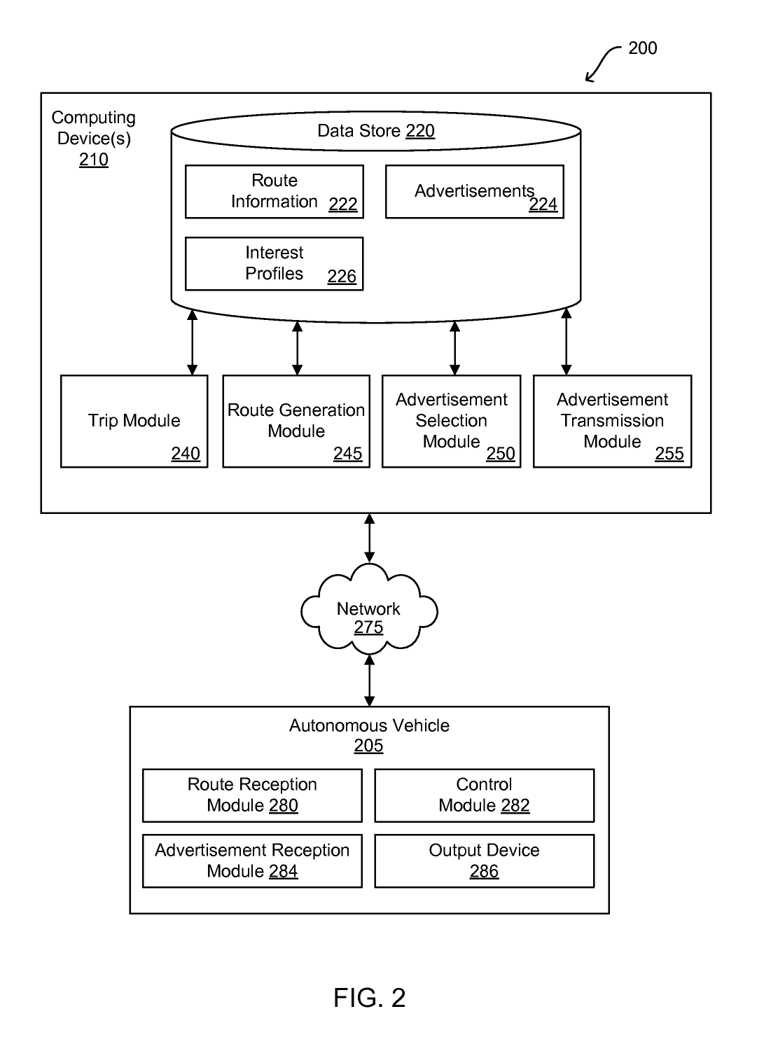

In the following discussion, a general description of an example system for providing advertisements to an autonomous vehicle and the system's components are provided. The general description is followed by a discussion of the operation of the components in a system for the technology. FIG. 2 illustrates a networked environment 200 according to one example of the present technology. The networked environment 200 may include one or more computing devices 210 in data communication with an autonomous vehicle 205 by way of a network 275. The network 275 may include the Internet, intranets, extranets, wide area networks (WANs), local area networks (LANs), wired networks, wireless networks, or other suitable networks, etc., or any combination of two or more such networks.

Various applications, services and/or other functionality may be executed in the computing device 210 according to varying embodiments. Also, various data may be stored in a data store 220 that is accessible to the computing device 210. The term “data store” may refer to any device or combination of devices capable of storing, accessing, organizing, and/or retrieving data, which may include any combination and number of data servers, relational databases, object oriented databases, simple web storage systems, cloud storage systems, data storage devices, data warehouses, flat files, and data storage configuration in any centralized, distributed, or clustered environment. The storage system components of the data store may include storage systems such as a SAN (Storage Area Network), cloud storage network, volatile or non-volatile RAM, optical media, or hard-drive type media. The data stored in the data store 220, for example, may be associated with the operation of the various applications and/or functional entities described below.

The data stored in the data store 220 may include route information 222. The route information 222 may include a route driven by the autonomous vehicle 205. The route information 222 may include a starting location for the autonomous vehicle 205, as well as a destination for the autonomous vehicle 205. In some examples, the starting location and the destination may be represented by addresses, geographical coordinates, street intersections, etc.

The data stored in the data store 220 may include advertisements 224. The advertisements 224 may be associated with entities located across a plurality of geographical regions. Some non-limiting examples of entities include, but are not limited to, restaurants, coffee shops, pubs, shopping centers, beauty salons, automobile dealerships, hospitals, medical centers, hotels, banks, florists, professional services, etc. The advertisements 224 may be for particular products or services. The advertisements 224 may involve promotions, deals, coupons, etc. The advertisements 224 may be stored in various electronic forms or digital formats, such as audio files, video files, textual content, etc. The advertisements 224 may be dynamically updated based on changes to various promotions, deals, etc. that are being offered by the entities. The advertisements 224 may be for display on a display screen within the autonomous vehicle 205. In some examples, the advertisements 224 may be banner advertisements, rich media advertisements, pop-up advertisements, floating advertisements, wallpaper advertisements, video advertisements, or expanding advertisements.

The data stored in the data store 220 may include interest profiles 226. The interest profiles 226 may describe interests for various passengers that ride in the autonomous vehicle 205. The interest profiles 226 may describe specific products (e.g., bicycles, electronic devices), specific product brands, specific subject areas (e.g., science, mathematics), specific services (e.g., automobile services), etc. that may be of interest to the passengers in the autonomous vehicle 205. The interest profiles 226 may indicate certain entities that are of interest to the passengers in the autonomous vehicle 205, such as particular restaurants, sports bars, coffee shops, ice cream parlors, shopping centers, automobile repair centers. In one example, the interest profiles 226 may be generated based on previous advertisements provided to the autonomous vehicle 205 and/or previous destinations traveled to by the autonomous vehicle 205. In another example, the interest profiles 226 may include, for each passenger, demographical information, a browsing history, a search history and/or a purchase history.

The components executed on the computing device 210 may include a trip module 240, a route generation module 245, an advertisement selection module 250, an advertisement transmission module 255, and other applications, services, processes, systems, engines, or functionality not discussed in detail herein. The trip module 240 may be configured to receive a starting location and a destination for the autonomous vehicle 205. In some examples, the starting location and the destination may be represented by addresses, geographical coordinates, street intersections, etc. As a non-limiting example, the starting location may be the autonomous vehicle's current geographical location and the destination may be a particular entity (e.g., a grocery store).

The route generation module 245 may be configured to generate a route for the autonomous vehicle 205 to drive from the starting location to the destination. The route generation module 245 may generate the route such that the route is in proximity to at least one entity that provides a product or service of interest to a passenger within the autonomous vehicle 205. The product or service of interest to the passenger may be indicated in the passenger's interest profile 226. In other words, entities that provide these products or services may be identified, and then the route generation module 245 may generate the route to be in proximity to these entities. In some examples, the route generation module 245 may generate the route to be within a predefined threshold of a shortest-distance route between the starting location and the destination and/or a shortest-time route between the starting location and the destination. As a non-limiting example, the route generation module 245 may generate the route to be within five minutes of the shortest-time route and within a half mile of the shortest-distance route. In one configuration, the route generation module 245 may send the route to the autonomous vehicle 205.

In one configuration, the route generation module 245 may generate the route to be in proximity to certain types of entities based on a current time of day. For example, the route generation module 245 may generate the route to be in proximity to a bagel shop or coffee shop if the autonomous vehicle 205 is traveling in the morning, but if the autonomous vehicle 205 is traveling in the evening, the route generation module 245 may generate the route to be in proximity to sit-down restaurants.

The advertisement selection module 250 may be configured to select the advertisement 224 for the entity that is located in proximity to the route from the starting location to the destination. The advertisement 224 may be for the products or services provided by the identified entity, wherein the products or services are of interest to the passenger, as indicated in the interest profile 226. In one example, the advertisement selection module 250 may select the advertisement 224 based on a current time of day.

The advertisement transmission module 255 may be configured to transmit the advertisement 224 for the entity when the autonomous vehicle 205 is within a defined distance from the entity when driving along the route to the destination. The autonomous vehicle's location may be tracked as the autonomous vehicle 205 is driving to the destination, and based on the autonomous vehicle's current location on the route, the advertisement transmission module 255 may send the advertisement 224. As a non-limiting example, the advertisement transmission module 255 may send an advertisement for a sandwich shop when the autonomous vehicle is three minutes away from the sandwich shop when driving along the route to the destination.

Certain processing modules may be discussed in connection with this technology and FIG. 2. In one example configuration, a module of FIG. 2 may be considered a service with one or more processes executing on a server or other computer hardware. Such services may be centrally hosted functionality or a service application that may receive requests and provide output to other services or customer devices. For example, modules providing services may be considered on-demand computing that are hosted in a server, cloud, grid, or cluster computing system. An application program interface (API) may be provided for each module to enable a second module to send requests to and receive output from the first module. Such APIs may also allow third parties to interface with the module and make requests and receive output from the modules. Third parties may either access the modules using authentication credentials that provide on-going access to the module or the third party access may be based on a per transaction access where the third party pays for specific transactions that are provided and consumed.

The computing device 210 may comprise, for example, a server computer or any other system providing computing capability. For purposes of convenience, the computing device 210 is referred to herein in the singular. Even though the computing device 210 is referred to in the singular, it is understood that a plurality of computing devices 210 may be employed.

The autonomous vehicle 205 may be configured to receive advertisements 224 from the computing device 210. The autonomous vehicle 205 may include a route reception module 280, a control module 282, an advertisement reception module 284, and other applications, services, processes, systems, engines, or functionality not discussed in detail herein. The route reception module 280 may be configured to receive, from the computing device 210, the route for traveling from the starting location (e.g., the current location associated with the autonomous vehicle 205) to the destination. The route may be within a defined threshold of a shortest distance route or a shortest travel-time route between the starting location and the destination. In addition, the route may be optimized using real-time traffic information to reduce a driving time and/or distance when driving from the starting location to the destination.

The control module 282 may be configured to provide commands to drive the autonomous vehicle 205 to the destination according to the route. In other words, the control module 282 may provide commands for traveling from the starting location to the destination. In particular, the control module 282 may provide commands to the autonomous vehicle's actuators, thereby controlling steering, acceleration, braking and throttle of the autonomous vehicle 205.

The advertisement reception module 284 may be configured to receive one or more advertisements 224 when traveling along the route to the destination. The advertisement reception module 284 may receive the advertisements 224 in an audio format, a video format, a textual format, or a combination thereof. The advertisement reception module 284 may receive a particular advertisement for a business entity when the autonomous vehicle 205 is a defined distance (e.g., a half mile) or time (e.g., five minutes) away from the business entity when traveling to the destination. The advertisement 224 may be displayed and/or played on a device with a display screen within the autonomous vehicle 205.

The autonomous vehicle 205 may include or be coupled to an output device 286. The output device 286 may comprise, for example, one or more devices such as cathode ray tubes (CRTs), liquid crystal display (LCD) screens, gas plasma-based flat panel displays, LCD projectors, or other types of display devices, etc.

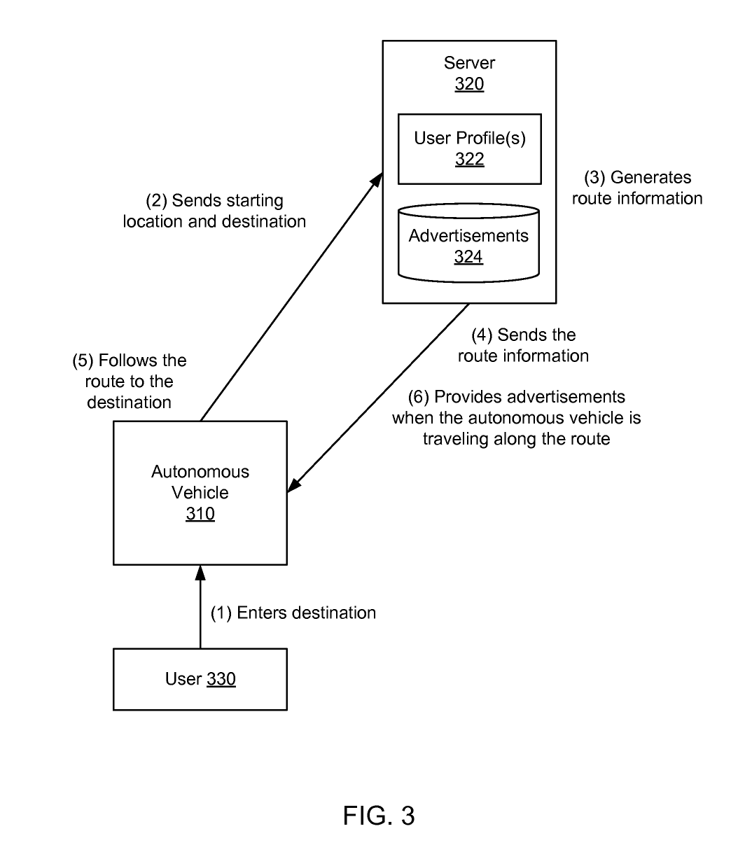

FIG. 3 illustrates an exemplary system and related operations for providing advertisements 324 to an autonomous vehicle 310. The advertisements 324 may be provided to the autonomous vehicle 310 from a server 320 when the autonomous vehicle 310 is driving to a destination. In one example, the server 320 may be associated with an advertisement provider or an advertisement exchange platform. The advertisements 324 may be displayed on a display screen within the autonomous vehicle 310 when the autonomous vehicle is traveling to destination. The advertisements 324 may be for entities that are located in proximity to a route taken by the autonomous vehicle 310 when driving to the destination. The advertisements 324 may include information related to products or services offered at the entities, wherein the products or services are of interest to a user 330 in the autonomous vehicle 310.

In one example, the user 330 may enter into the autonomous vehicle 310. The user 330 may be an owner of the autonomous vehicle 310 and/or authorized to use the autonomous vehicle 310. The user 330 may enter a destination via a console inside the autonomous vehicle 310 (e.g., a touch screen device). The destination may include an address, a name of a business (e.g., a restaurant, bank), geographical coordinates, etc. The autonomous vehicle 310 may determine a starting location, such as a current location of the autonomous vehicle 310. For example, the autonomous vehicle 310 may use a global positioning system (GPS) to determine its starting location. The autonomous vehicle 310 may send the starting location and the destination to the server 320.

The server 320 may receive the starting location and the destination from the autonomous vehicle 310. The server 320 may generate the route for the autonomous vehicle 310 to follow when driving from the starting location to the destination. The route may indicate a series of turns the autonomous vehicle 310 is to make when driving to the destination.

In one example, the server 320 may generate the route based on a user profile 322 associated with the user 330 in the autonomous vehicle 310. The user profile 322 may indicate products and/or services that are of interest to the user 330 in the autonomous vehicle 310. As non-limiting examples, the user profile 322 may indicate that the user 330 likes certain types of food or beverages, certain department stores, certain restaurants, etc. The user profile 322 may also include demographical information, a browsing history, a search history, a purchase history, etc. associated with the user 330 in the autonomous vehicle 310. Based on the user profile 322, the server 320 may generate the route to be in proximity to at least one entity that provides the products and/or services that interest the user 330 in the autonomous vehicle 310. The entities may include businesses (e.g., restaurants, coffee shops, and pizza places), organizations, churches, parks, libraries, etc. In other words, the server 320 may identify entities that provide the products or services that interest the user 330, and then generate the route between the starting location and the destination to be in proximity to these entities. Therefore, when the autonomous vehicle 310 drives along the route to the destination, the autonomous vehicle 310 may drive by entities providing products or services that are potentially of interest to the user 330 in the autonomous vehicle 310.

In one example, the server 320 may generate the route to be within a predefined threshold of a shortest-distance route and/or a shortest-time route between the starting location and the destination. For example, the server 320 may generate the route so that the autonomous vehicle 310 may drive by several entities of interest, but the route may be within a certain distance or time limit. As a non-limiting example, the server 320 may generate the route to be within two miles of a shortest-distance route between the starting location and the destination. As another non-limiting example, the server 320 may generate the route to be within five minutes of a shortest-time route between the starting location and the destination.

In one configuration, the server 320 may send the route to the autonomous vehicle 310. The autonomous vehicle 310 may receive the route from the server 320. The autonomous vehicle 310 may drive to the destination using the route received from the server 320. In particular, one or more processors of the autonomous vehicle 310 may provide commands to drive the autonomous vehicle 310 from the starting location to the destination. The one or more processors of the autonomous vehicle 310 may provide commands to the autonomous vehicle's actuators, thereby controlling steering, acceleration, braking and throttle of the autonomous vehicle 310.

When the autonomous vehicle 310 is driving to the destination, the server 320 may send one or more advertisements 324 to the autonomous vehicle 310. The advertisements 324 may be displayed on a display screen inside the autonomous vehicle 310. The advertisements 324 may be for the entities that are located in proximity to the route. In other words, the server 320 may select advertisements for the products or services provided by the entities located in proximity to the route, wherein the products or services are of interest to the user 330, as indicated in the user profile 322. In one example, the advertisements 324 may be related to sales or discounts for products or services that are related to the user profile 322. The advertisements 324 may include promotional offers or coupons for the user 330 for a business entity associated with the advertisement 324. Therefore, when the user 330 is traveling to the destination, the user 330 may be provided with advertisements 324 for business entities that are enroute to the destination.

In one example, the server 320 may detect when the autonomous vehicle 310 is within a defined distance from one of the business entities of interest when the autonomous vehicle 310 is driving along the route to the destination. For example, the server 320 may detect when the autonomous vehicle 310 is five minutes away from the business entity. The server 320 may provide the advertisement 324 related to the business entity for display inside the autonomous vehicle 310. Therefore, the user 330 may view the advertisement 324 before the autonomous vehicle 310 drives by the business entity on the route, which may provide the user 330 with adequate time to determine whether the autonomous vehicle 310 should stop at the business entity.

In one configuration, the route and the advertisements 324 may be transmitted to the autonomous vehicle 310 at the same time, and the advertisements 324 may be locally stored at the autonomous vehicle 310. The autonomous vehicle 310 may detect when a particular entity is nearby, and the autonomous vehicle 310 may retrieve a stored advertisement 324 related to that business entity for display inside the autonomous vehicle 310. Therefore, the user 330 may view the advertisements 324 (e.g., promotions, deals or coupons) for the business entities while traveling along the route to the destination.

In one example, the entity may be charged an advertisement fee each time their advertisement 324 is provided to the autonomous vehicle 310. In other words, the entity may provide compensation for the server 320, which may be associated with an advertisement provider, generating the route to be in proximity to the entity, which allows the entity's advertisement 324 to be provided to the user 330.

In another example, the route generated by the server 320 may be in proximity to multiple entities that provide products or services of interest to the user 330, and the multiple entities may partake in a bidding process to provide their respective advertisement 324 to the user 330 in the autonomous vehicle 310. In one example, the entity that submits the highest bid among the multiple entities may win the bidding process, and therefore, the server 320 may select the advertisement 324 related to that entity for transmission to the autonomous vehicle 310. As a non-limiting example, the route generated by the server 320 may be in proximity to five entities that offer products or services that are of interest to the user 330. Each of the five entities may place a bid to provide their respective advertisement 324 when the autonomous vehicle 310 is traveling along the route. The advertisement 324 may be provided to the autonomous vehicle 310 depending on the one entity that places a highest bid price as compared to the other four entities.

In one configuration, the server 320 may provide particular advertisements 324 to the user 330 based on a time of day. As a non-limiting example, the user profile 322 may indicate that the user 330 likes doughnuts and Chinese food. Therefore, the server 320 may generate the route to be in proximity to a breakfast cafe that provides doughnuts and a Chinese restaurant that provides Chinese food. When the autonomous vehicle 310 is driving along the route in the morning, the server 320 may provide advertisements 324 for the breakfast café. When the autonomous vehicle 310 is driving along the route in the evening, the server 320 may provide advertisements 324 for the Chinese restaurant. Therefore, the advertisements 324 may be selected based on the time of day during which the autonomous vehicle 310 is driving along to route.

In one configuration, the server 320 may identify a set of candidate routes or potential routes for the autonomous vehicle 310 to take based on the starting location and the destination. The candidate routes may be in proximity to business entities that are of interest to the user 330. In addition, the potential routes may be within a defined threshold of a shortest-distance route or a shortest-time route between the starting location and the destination. The server 320 may evaluate a financial benefit (e.g., advertising revenue) for each of the candidate routes when determining which route to provide to the autonomous vehicle 310. For example, the server 320 may facilitate a real-time bidding auction between the business entities when determining which candidate route is to be provided to the autonomous vehicle 310, and consequently, which advertisement 324 is to be provided to the autonomous vehicle 310. The business entities may submit a bid to the server 320 to provide their particular advertisement 324 to the user 330 when the autonomous vehicle 310 is driving to the destination. Each of the business entities that are submitting bids may set a maximum bid price. The bidding process may be performed, and a particular business entity may submit the highest bid and win the auction. Therefore, the server 320 may generate the route such that the route is in proximity to the business entity that wins the bidding auction. When the autonomous vehicle 310 is in proximity to that business entity when traveling along the route, the server 320 may send an advertisement 324 associated with that business entity to the autonomous vehicle 310. Therefore, the server 320 may generate the route to be in proximity to the business entity that submits a winning bid during the bidding auction. As a result, the business entity may advertise their products or services when the autonomous vehicle 310 is following the route to the destination, and the proximity between the autonomous vehicle 310 and the business entity may entice the user 330 to stop at the business entity for purchase of goods or services.

As a non-limiting example, the server 320 may identify three potential routes for the autonomous vehicle 310 to take when driving from home to the user's workplace. Based on the user profile 322, the server 320 may identify three potential businesses that are of interest to the user 330—a pizza place, a sandwich shop, and a movie rental store. If the autonomous vehicle 310 follows route A, the autonomous vehicle 310 may drive by the pizza place. If the autonomous vehicle 310 follows route B, the autonomous vehicle 310 may drive by the sandwich shop. If the autonomous vehicle 310 follows route C, the autonomous vehicle 310 may drive by movie rental store. In order to determine which of the three routes to provide to the autonomous vehicle 310, the server 320 may initiate a bidding auction between the pizza place, the sandwich shop, and the movie rental store. For example, the pizza place may place a maximum bid of $4 to provide their respective advertisement 324 to the user 330. The sandwich shop may place a maximum bid of $1 to provide their respective advertisement 324 to the user 330. The movie rental store may place a maximum bid of $2 to provide their respective advertisement 324 to the user 330. Therefore, the pizza place may win the bidding auction over the sandwich shop and the movie rental store. The server 320 may provide route A to the autonomous vehicle 310, such that the autonomous vehicle 310 drives by the pizza place when following the route to the destination. When the autonomous vehicle 310 is located relatively close to the pizza place (e.g., five minutes away), the server 320 may provide an advertisement 324 associated with the pizza place for display inside the autonomous vehicle 310. The user 330 may view the advertisement 324 for the pizza place, and determine whether the autonomous vehicle 310 should stop at the pizza place on the way to the destination.

In one example, the server 320 may identify a single route from the starting location to the destination that is within the defined threshold with respect to a shortest-distance route and a shortest-time route. The server 320 may identify a number of business entities that are along the route and related to the user profile 322. The server 320 may provide advertisements 324 related to the business entities that are along the route. In this case, the business entities may not compete with each other for providing their respective advertisements 324 to the autonomous vehicle 310. Rather, the server 320 may choose to provide all of the advertisements 324 for the business entities when the autonomous vehicle 310 is traveling along the route from the starting location to the destination. In addition, a fee may be charged to each of the business entities along the route that provide advertisements 324 to the autonomous vehicle 310.

In another example, a business entity may have an established agreement to provide their advertisement 324 to users when the business entity is in proximity to the route generated by the server 320. As a non-limiting example, business A may sell men's suits and is located on Main Street. For each route generated by the server 320 that involves driving through Main Street, the server 320 may provide an advertisement 324 for business A to the autonomous vehicle 310 when the user profile 322 indicates an interest in men's formal wear. The advertising provider associated with the server 320 may collect a fee from business A when the advertisement 324 for men's suits is provided to the autonomous vehicle 310. In other words, the advertisement provider may be compensated on a per impression basis by the business entity.

In one example, when the autonomous vehicle 310 drives from the same starting location to the same destination on a regular basis (e.g., from home to work), the server 320 may slightly vary the route generated for the autonomous vehicle 310. As a result, different advertisements 324 for different business entities may be provided to the autonomous vehicle 310, but each of the business entities may be related to the user profile 322. For example, the user profile 322 may indicate that the user 330 likes coffee, sushi, and polo shirts. On a first day, the autonomous vehicle 310 may generate the route, such that the autonomous vehicle 310 drives by a coffee shop when driving to the destination. On a second day, the autonomous vehicle 310 may generate the route, such that the autonomous vehicle 310 drives by a sushi restaurant when driving to the destination. On a third day, the autonomous vehicle 310 may generate the route, such that the autonomous vehicle 310 drives by a clothing store when driving to the destination. Each of the routes may be relatively close in time and/or distance from each other. For example, a travel time for all three routes may be within five minutes of each other. Therefore, the user 330 may be exposed to a diverse mix of business entities when the autonomous vehicle 310 is driving to the destination.

In one configuration, the server 320 may learn which business entities generate the most interest for the user 330. For example, if the user 330 is exposed to an advertisement 324 for a coffee shop, and then stops at the coffee shop, then the server 320 may continue to provide advertisements 324 for the coffee shop and/or advertisements 324 for similar business establishments on following days. On the other hand, if the user 330 is exposed to an advertisement 324 for a particular clothing store, but the user 330 never stops at the clothing store, then the server 320 may not continue to provide advertisements 324 for the clothing store. Rather, the server 320 may determine alternative types of advertisements 324 to send to the user 330. Therefore, the server 320 may learn which advertisements 324 resonate with the user 330, and which advertisements 324 do not resonate with the user 330.

As a non-limiting example, the user 330 may enter the autonomous vehicle 310 and indicate to the autonomous vehicle 310 a desire to go to a shopping mall. The user 330 may enter a name of the shopping mall at a console of the autonomous vehicle 310. The autonomous vehicle 310 may send a starting location and the destination to the server 320. The server 320 may evaluate a plurality of potential routes for the autonomous vehicle 310 to take when traveling from the starting location to the shopping mall. The server 320 may generate the route to be in proximity to one or more business entities that are of interest to the user 330, as indicated by the user profile 322. The user profile 322 may indicate that the user 330 likes frozen yogurt and hamburgers. The server 320 may identify a first route that is in proximity to a frozen yogurt establishment, and a second route that is in proximity to a hamburger joint. Both the frozen yogurt establishment and the hamburger joint may submit a bid to the server 320 to show their respective advertisement 324 to the user. As an example, the hamburger joint may win a bidding auction over the frozen yogurt establishment. Therefore, the server 320 may generate the route for traveling to the shopping mall to be in proximity to the hamburger joint. The server 320 may send the route to the autonomous vehicle 310. The autonomous vehicle 310 may drive to the shopping mall in accordance with the route received from the server 320. Prior to the autonomous vehicle 310 driving by the hamburger joint (which is in proximity to the route), the server 320 may provide the advertisement 324 that is related to the hamburger joint. The advertisement 324 may be displayed on a display screen within the autonomous vehicle 310. For example, the advertisement 324 may indicate that the hamburger joint is nearby and that the user 330 may receive a discount if the advertisement 324 is mentioned. Therefore, the user 330 may decide whether to instruct the autonomous vehicle 310 to stop at the hamburger joint, or if the autonomous vehicle 310 is to continue driving to the shopping mall.

In one example, the autonomous vehicle 310 may be part of a fleet of autonomous vehicles that provide taxi services to a plurality of users. The fleet of autonomous vehicles may be operated by a taxi service provider that serves a particular geographical area. For example, the autonomous vehicle 310 may pick up the user 330 at a pickup location and then drive the user 330 to a drop-off location in order to drop off the user 330. The autonomous vehicle 310 may drive from the pickup location to the drop-off location as part of the taxi service. Based on the user's interests, the server 320 may generate a route between the pickup location and the drop-off location to be in proximity to one or more business entities that provide products or services that are of interest to the user 330 inside the autonomous vehicle 310. In one example, advertisement revenue collected from the business entities that advertise to the user 330 may ease the financial strain on the taxi service provider.

The technology described herein may enable targeted advertisements to be provided to users. The targeted advertisements may be provided when the users are traveling in an autonomous vehicle to a destination, wherein the targeted advertisements are based on user interests. In addition, the advertising may be related to places that are enroute to the user's destination. As a result, users may not be seriously inconvenienced by traveling a relatively long ways off the route. Users may make a relatively quick stop to grab coffee, a sandwich, etc. after viewing the advertisements provided to the autonomous vehicle, and then continue traveling to the destination.

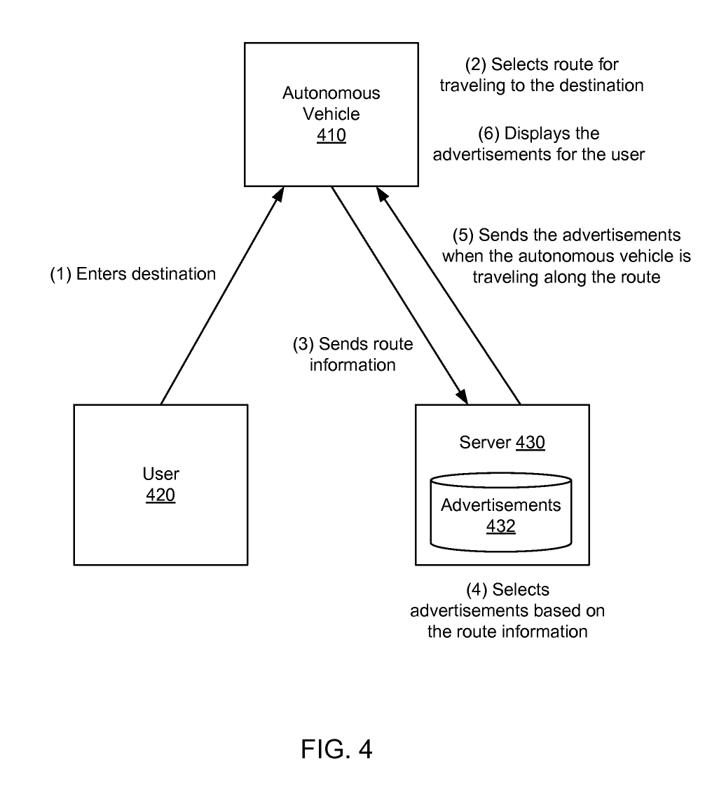

FIG. 4 illustrates an exemplary system and related operations for providing advertisements 432 to an autonomous vehicle 410. The advertisements 432 may be provided from a server 430 to the autonomous vehicle 410 for display when the autonomous vehicle 410 is driving along a route to a destination. In one example, the server 430 may be associated with an advertisement provider or an advertisement exchange platform. The advertisements 432 may be for business entities that are located in proximity to the route followed by the autonomous vehicle 410 when driving to the destination. The advertisements 432 may include information related to products or services offered at the business entities that are located in proximity to the route.

In one example, a user 420 may enter the destination into the autonomous vehicle 410. The user 420 may enter the destination via a console inside the autonomous vehicle 410 (e.g., a touch screen device). The destination may include an address, a name of a business, etc. The autonomous vehicle 410 may determine, for example, via a navigation system, an optimal route for traveling from a current location associated with the autonomous vehicle 410 to the destination. For example, the navigation system of the autonomous vehicle 410 may determine a shortest-distance route or a shortest-time route for traveling from the autonomous vehicle's current location to the destination. In this case, the autonomous vehicle 410 may determine the route, as opposed to the server 430.

The autonomous vehicle 410 may send the route for traveling to the destination to the server 430. The server 430 may identify one or more businesses entities along the route that are potentially of interest to the user 420. The business entities may provide products or services that are potentially of interest to the user 420. In one example, the server 430 may identify the business entities based on a user profile associated with the user. The user profile may include demographical information, a browsing history, a search history, a purchase history, etc. associated with the user 420 in the autonomous vehicle 410. The user profile may indicate that the user 420 likes certain types of products or services (e.g., food, beverages, clothing, sports equipment). Based on the products and/or services included in the user profile, the server 430 may identify business entities in proximity to the route that provide these products and/or services. In one example, the business entities identified by the server 430 may be within a certain distance or time from the route.

The autonomous vehicle 410 may drive to the destination according to the route that is generated at the autonomous vehicle 410. In particular, one or more processors of the autonomous vehicle 410 may provide commands to drive the autonomous vehicle 410 to the destination in accordance with the route. When the autonomous vehicle 410 is driving to the destination, the server 430 may send one or more advertisements 432 for display in the autonomous vehicle 410. The advertisements 432 provided by the server 430 may be for the identified business entities that are in proximity to the route and are potentially of interest to the user 420. In particular, the advertisements 432 may be related to products or services that are indicated in the user profile. Therefore, when the user 420 is traveling to the destination, the user 420 may be provided with advertisements 432 for business entities that are enroute to the destination. The server 430 may provide a particular advertisement 432 for a business entity when the autonomous vehicle 410 is relatively close (e.g., one mile away) to passing the business entity enroute to the destination. The server 430 may track a current location of the autonomous vehicle 410 to determine when the advertisement 432 should be provided to the autonomous vehicle 410.

In one configuration, the autonomous vehicle 410 may not send its route to the server 430. Rather, the server 430 may track a current location of the autonomous vehicle 410 when the autonomous vehicle 410 is driving to a destination. The server 430 may select advertisements 432 for business entities that are located in proximity to the current location of the autonomous vehicle 410. The advertisements 432 may be related to interests indicated in the user profile. The server 430 may provide the advertisements 432 to the autonomous vehicle 410 when the autonomous vehicle 410 is driving to the destination.

In one example, the server 430 may select which advertisements 432 to provide to the user 420 using a bidding auction. The server 410 may initially identify a plurality of business entities along the route that are of potential interest to the user 420. The server 410 may evaluate a financial gain (e.g., advertising revenue) from each of the business entities along the route that are of potential interest to the user 420. The server 430 may facilitate a real-time bidding auction between the business entities when determining which advertisements 432 are to be transmitted to the autonomous vehicle 410. The server 430 may have a fixed number of advertisement slots for the advertisements 432 that are to be transmitted to the autonomous vehicle 410. The business entities may submit a bid to the server 430 to show their particular advertisement 432 to the user 420 when the autonomous vehicle 410 is driving to the destination. Each of the business entities that are submitting bids may set a maximum bid price. The bidding auction may be performed, and the business entities that submit the highest bids may win the auction. The server 430 may provide the advertisements 432 associated with these business entities when the autonomous vehicle 410 is traveling to the destination. Therefore, in one example, the autonomous vehicle 410 may select the advertisements 432 to provide to the autonomous vehicle 410 based on advertising revenue.

In an alternative configuration, the server 430 may not have a fixed number of advertisement slots for the advertisements 432 that are to be transmitted to the autonomous vehicle 410. The server 430 may provide advertisements 432 for business entities that are along the route when the autonomous vehicle 410 is traveling to the destination. If the user 420 selects a particular advertisement 432, or the user 420 directs the autonomous vehicle 410 to visit a business establishment based on a particular advertisement 432, then the business entity associated with the advertisement 432 may provide compensation (e.g., to an advertisement provider that is associated with the server 430).

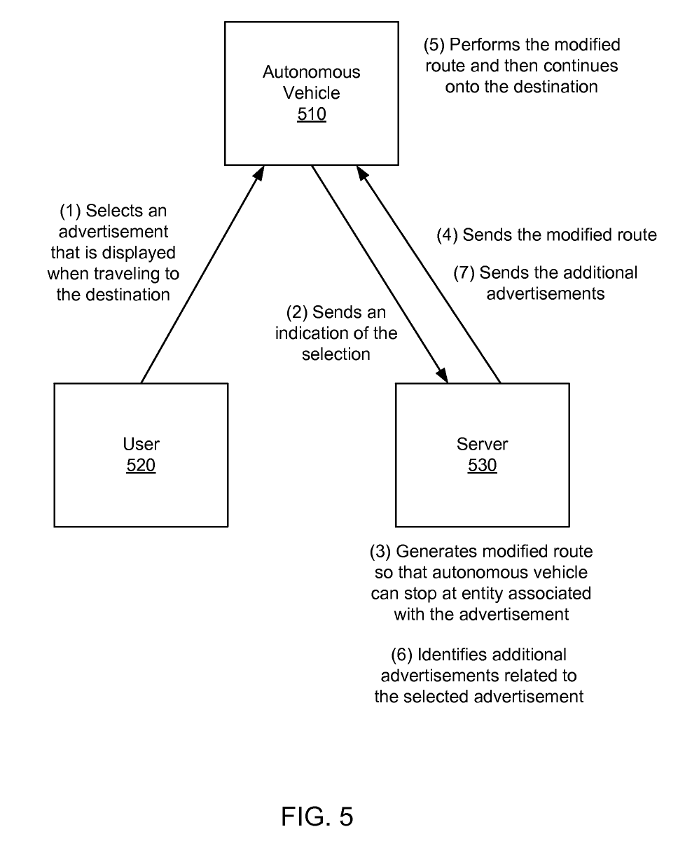

FIG. 5 illustrates an exemplary system and related operations for providing advertisements to an autonomous vehicle 510. A server 530 associated with an advertisement provider may provide the advertisements for display to a user 520 within the autonomous vehicle 510. The server 530 may provide the advertisements when the autonomous vehicle 510 is driving along a route to a destination. The advertisements may be for business entities (e.g., restaurants, bookstores) that are located in proximity to the route and are of interest to the user 520 In addition, the server 530 may generate the route that is being taken by the autonomous vehicle 510, such that the route is located in proximity to the business entities that are of interest to the user 520.

In one example, the user 520 may view an advertisement for a business entity that is provided to the autonomous vehicle 510 from the server 530. Based on the advertisement, the user 520 may be interested in stopping at the business entity, and then afterwards, continuing on to the destination. The user 520 may select the advertisement that is displayed inside the autonomous vehicle 510. In one example, the autonomous vehicle 510 may indicate the selection of the advertisement to the server 530. The server 530 may generate a modified route that involves the autonomous vehicle 510 stopping at the business entity while enroute to the destination. The server 530 may send the modified route to the autonomous vehicle 510.

The autonomous vehicle 510 may digress from the previous route and drive to the business entity in accordance with the modified route. After the user 520 has spent a sufficient amount of time at the business entity, the user 520 may return to the autonomous vehicle 510. The autonomous vehicle 510 may drive to the destination in accordance with the modified route. In one example, the autonomous vehicle 510 may drive back to a previous location (e.g., a location at which the autonomous vehicle 510 digressed from the previous route to drive to the business entity), and then continue on to the destination in accordance with the previous route.

In one example, the server 530 may store which advertisements are selected by the user 520 and the business entities associated with those advertisements. Based on the advertisements that are selected by the user 520, the server 530 may determine which types of business entities the user 520 is most likely to visit. The server 530 may generate future routes to be in proximity to these types of business entities. The server 530 may identify additional advertisements that are related to these types of business entities. In other words, these additional advertisements may be related to the advertisements that were previously selected by the user 520. The server 530 may send the additional advertisements to the autonomous vehicle 510 for consumption by the user 520.

In an alternative configuration, the autonomous vehicle 510 may be driving from the starting location to the destination along a route that is selected by the autonomous vehicle 510, as opposed to the server 530. The user 520 may instruct the autonomous vehicle 510 to stop at a certain business entity in response to an advertisement for the business entity that is provided to the autonomous vehicle 510 from the server 530. The autonomous vehicle 510 may generate a modified route that involves driving to the business entity, and then driving to the destination. The autonomous vehicle 510 may send the modified route to the server 530. Based on the modified route, the server may select advertisements to send to the autonomous vehicle 510 for business entities that are in proximity to the modified route.

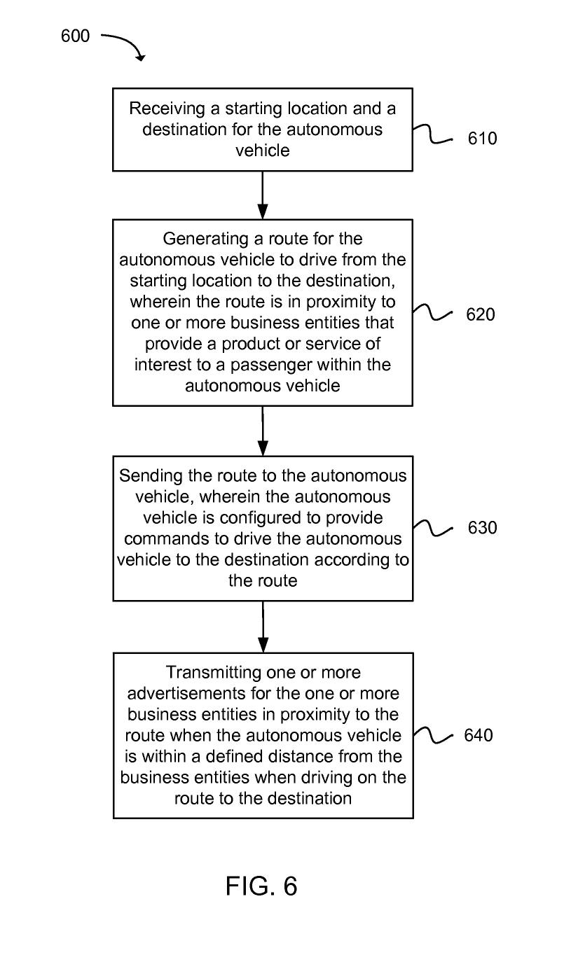

FIG. 6 illustrates an example of a method for providing advertisements to an autonomous vehicle. The method may be executed as instructions on a machine, where the instructions are included on at least one computer readable medium or one non-transitory machine readable storage medium. The method may be executed by one or more processors on the machine. The method may include the operation of receiving a starting location and a destination for the autonomous vehicle, as in block 610. The method may include the operation of generating a route for the autonomous vehicle to drive from the starting location to the destination, wherein the route is in proximity to one or more business entities that provide a product or service of interest to a passenger within the autonomous vehicle, as in block 620. The method may include the operation of sending the route to the autonomous vehicle, wherein the autonomous vehicle is configured to provide commands to drive the autonomous vehicle to the destination according to the route, as in block 630. The method may include the operation of transmitting, using the one or more processors, one or more advertisements for the one or more business entities in proximity to the route when the autonomous vehicle is within a defined distance from the business entities when driving on the route to the destination, as in block 640.

In one example, the method may include the operation of generating the route to be in proximity to the business entities using an interest profile of the passenger within the autonomous vehicle. In one example, the interest profile includes at least one of: demographical information, a browsing history, a search history or a purchase history. In one example, the advertisements for the business entities are selected based on a current time of day.

In one example, the route is within a predefined threshold of a shortest-distance route between the starting location and the destination; or the route is within a predefined threshold of a shortest-time route between the starting location and the destination. In one example, the autonomous vehicle is included in a fleet of autonomous vehicles which provide taxi services to customers.

In one example, the method may include the operations of: detecting that the autonomous vehicle is within the defined distance from a business entity when driving on the route to the destination; and transmitting the advertisement for the business entity to the autonomous vehicle. In one example, the method may include the operations of: receiving an indication when the passenger within the autonomous vehicle selects an advertisement provided to the autonomous vehicle; selecting additional advertisements for business entities in proximity to the route that are related to the advertisement selected by the passenger; and transmitting the additional advertisements when the autonomous vehicle is driving on the route to the destination.

In one example, the method may include the operations of: receiving a message when the passenger within the autonomous vehicle provides commands to redirect the autonomous vehicle to a business entity associated with an advertisement transmitted to the autonomous vehicle; generating a modified route for the autonomous vehicle to drive to the business entity; and sending the modified route to the autonomous vehicle, wherein the autonomous vehicle is configured to provide commands to drive the autonomous vehicle to the business entity in accordance with the modified route. In one example, the method may include the operations of: receiving a current location of the autonomous vehicle; selecting advertisements for business entities that are located in proximity to the current location of the autonomous vehicle; and providing the advertisements to the autonomous vehicle.

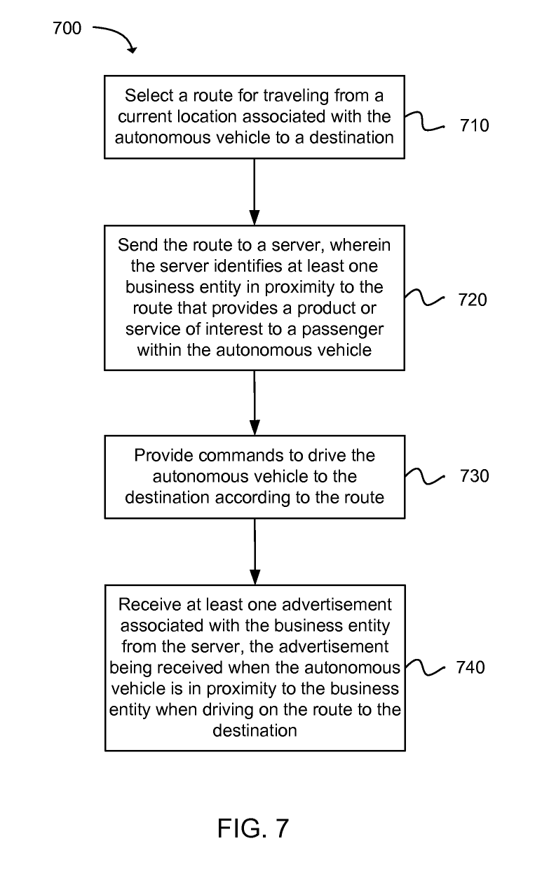

Another example provides functionality 700 of an autonomous vehicle operable to receive advertisements, as shown in the flow chart in FIG. 7. The functionality can be implemented as a method or the functionality can be executed as instructions on a machine, where the instructions are included on at least one computer readable medium or one non-transitory machine readable storage medium. The method may be executed by one or more processors on the machine. The autonomous vehicle may be configured to select a route for traveling from a current location associated with the autonomous vehicle to a destination, as in block 710. The autonomous vehicle may be configured to send the route to a server, wherein the server identifies at least one business entity in proximity to the route that provides a product or service of interest to a passenger within the autonomous vehicle, as in block 720. The autonomous vehicle may be configured to provide commands to drive the autonomous vehicle to the destination according to the route, as in block 730. The autonomous vehicle may be configured to receive at least one advertisement associated with the business entity from the server, the advertisement being received when the autonomous vehicle is in proximity to the business entity when driving on the route to the destination, as in block 740.

In one example, the autonomous vehicle may display the advertisement on a display screen within the autonomous vehicle. In one example, the autonomous vehicle may receive instructions from the passenger within the autonomous vehicle to stop at the business entity after receiving the advertisement for the business entity; calculate a modified route for redirecting the autonomous vehicle to the business entity before driving to the destination; and provide commands to drive the autonomous vehicle to the destination in accordance with the modified route.

In one example, the advertisement is received for the business entity when the autonomous vehicle is at a predetermined distance from the business entity when driving on the route to the destination. In one example, the advertisement is for at least one of: a product, a service, a deal, a promotion or a coupon. In one example, the advertisement received from the server corresponds to an interest profile of the passenger within the autonomous vehicle, wherein the interest profile includes at least one of: demographical information, a browsing history, a search history or a purchase history.

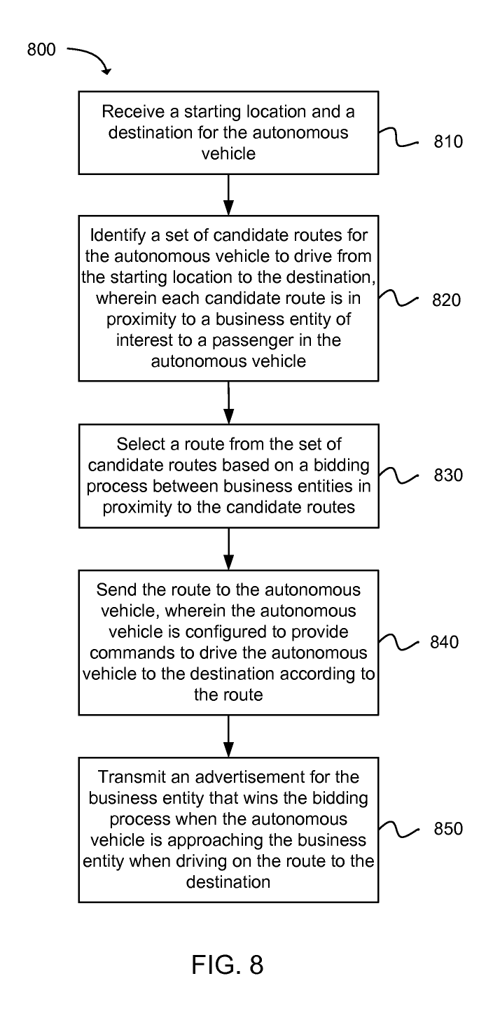

Another example provides functionality 800 of a system for providing advertisements to an autonomous vehicle, as shown in the flow chart in FIG. 8. The functionality can be implemented as a method or the functionality can be executed as instructions on a machine, where the instructions are included on at least one computer readable medium or one non-transitory machine readable storage medium. The method may be executed by one or more processors on the machine. The system may be configured to receive a starting location and a destination for the autonomous vehicle, as in block 810. The system may be configured to identify a set of candidate routes for the autonomous vehicle to drive from the starting location to the destination, wherein each candidate route is in proximity to a business entity of interest to a passenger in the autonomous vehicle, as in block 820. The system may be configured to select a route from the set of candidate routes based on a bidding process between business entities in proximity to the candidate routes, as in block 830. The system may be configured to send the route to the autonomous vehicle, wherein the autonomous vehicle is configured to provide commands to drive the autonomous vehicle to the destination according to the route, as in block 840. The system may be configured to transmit an advertisement for the business entity that wins the bidding process when the autonomous vehicle is approaching the business entity when driving on the route to the destination, as in block 850.

In one example, the business entity provides at least one of a product, a service, a deal, a promotion or a coupon of interest to the passenger within the autonomous vehicle. In one example, the route is within a predefined threshold of a shortest-distance route or a shortest-time route between the starting location and the destination. In one example, a distance or driving time between the starting location and the destination for each of the candidate routes is within a defined range. In one example, the route is generated to be in proximity to the business entity of interest that provides at least one of a product, a service, a deal, a promotion or a coupon of interest to the passenger within the autonomous vehicle. In one example, the route is generated to be within a predefined threshold of a shortest-distance route or a shortest-time route between the starting location and the destination.

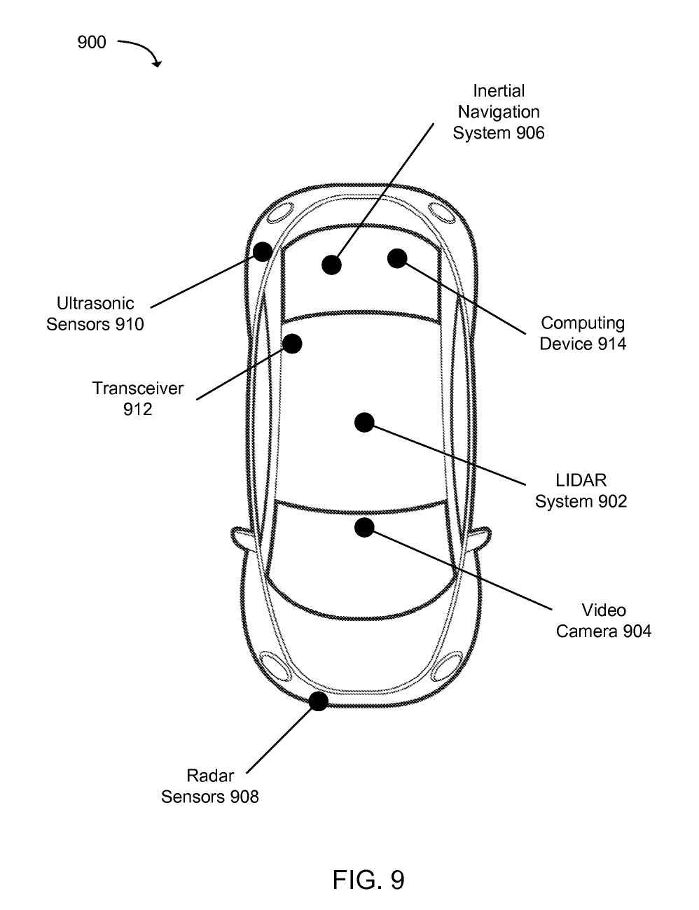

FIG. 9 illustrates an example of an autonomous vehicle 900 that is capable of sensing a surrounding environment and navigating itself to a destination. The autonomous vehicle 900 may be classified as a “Level 0” autonomous vehicle, a “Level 1” autonomous vehicle, a “Level 2” autonomous vehicle, a “Level 3” autonomous vehicle, or a “Level 4” autonomous vehicle. In Level 0, a driver may control the autonomous vehicle 900 at substantially all times. The driver may be in complete and sole control of primary vehicle controls, such as brake, steering, throttle and motive power. In Level 1, one or more individual controls may be automated in the autonomous vehicle 900, such as electronic stability control or automatic braking, in which the vehicle may automatically assist with braking to enable the driver to regain control of the vehicle or stop faster than possible by acting alone. In Level 2, at least two controls may be automated in unison in the autonomous vehicle 900, such as adaptive cruise control in combination with lane keeping. In Level 3, the driver may cede full control of substantially all safety-critical functions to the autonomous vehicle 900 under certain traffic or environmental conditions. The autonomous vehicle 900 may sense when certain conditions necessitate the driver to retake control of the autonomous vehicle 900 and a sufficiently comfortable transition time may be provided for the driver to retake control of the autonomous vehicle 900. In Level 4, the autonomous vehicle 900 may perform substantially all safety-critical driving functions and monitor roadway conditions for an entire trip. The driver may provide destination or navigation input, but the driver may not be expected to control the autonomous vehicle 900 at any time during the trip. As the autonomous vehicle 900 may control all functions from start to stop, including parking functions, in level 4, the autonomous vehicle 900 may include both occupied and unoccupied vehicles. In one example, the autonomous vehicle 900 may be restricted to operating in certain environments or under certain conditions based on government regulations.

The autonomous vehicle 900 may include, but is not limited to, cars, trucks, motorcycles, buses, recreational vehicles, golf carts, trains, and trolleys. The autonomous vehicle 900 may include an internal combustion engine that operates using liquid fuels (e.g., diesel, gasoline). Alternatively, the autonomous vehicle 900 may include one or more electric motors that operate using electrical energy stored in batteries. The autonomous vehicle 900 may include, but is not limited to, a light detection and ranging (LIDAR) system 902, a video camera 904, an inertial navigation system 906, radar sensors 908, ultrasonic sensors 910, a transceiver 912, and a computing device 914 that, while working together in combination, enable the autonomous vehicle 900 to sense the environment and navigate to the destination with reduced user input. The autonomous vehicle 900 may use information captured by the various sensors, cameras, etc. to safely drive the autonomous vehicle 900 on a route to a destination, while avoiding obstacles and obeying traffic laws. The autonomous vehicle 900 may perform a series of steps when following the route to the destination. For example, the autonomous vehicle 900 may drive 500 meters, turn right, drive 1000 meters, turn left, etc. in order to reach the destination.

The LIDAR system 902 (also known as a laser range finder) may be mounted onto a surface (e.g., a top surface) of the autonomous vehicle 900. The LIDAR system 902 may emit a plurality of light pulses and measure an amount of time for the light pulses to return to the autonomous vehicle 900, thereby allowing the LIDAR system 902 to measure the distance of objects surrounding the autonomous vehicle 900. As a non-limiting example, the LIDAR system 902 may measure the distance of objects within 200 meters from the autonomous vehicle 900.

One or more video cameras 904 may be mounted to a front, rear or side portion of the autonomous vehicle 900. The autonomous vehicle 900 may use the LIDAR system 902 and the video camera 904 to build a three-dimensional (3D) map of the autonomous vehicle's surroundings. The 3D map may capture a 360-degree view around the autonomous vehicle 900. In one example, the 3D map may capture the autonomous vehicle's surroundings within 200 meters. The 3D map may include a variety of features, such as road edges, road signs, lane markings, guardrails, overpasses, etc. The 3D map may indicate stationary objects, such as buildings, telephone poles, mailboxes, etc. In addition, the 3D map may indicate moving objects, such as other vehicles, bicyclists, pedestrians, etc.

In one example, the 3D map generated using the LIDAR system 902 and the video camera 904 may be correlated with high-resolution maps of the world. The high-resolution maps may indicate lane markings, terrain, elevation, speed limits, and other features related to the route taken by the autonomous vehicle 900 when driving to the destination. In addition, the autonomous vehicle 900 may position or localize itself within the 3D map. In other words, the autonomous vehicle 900 may determine its position in relation to the objects included in the 3D map. The autonomous vehicle 900 may determine its position by using the inertial navigation system 906. The inertial navigation system 906 may calculate a position, orientation, and velocity (i.e., direction and speed of movement) of the autonomous vehicle 900.

The inertial navigation system 906 may include a combination of gyroscopes, altimeters, tachometers, gyroscopes and other motion-sensing devices in order to calculate the autonomous vehicle's position. The inertial navigation system 906 may determine an initial position and velocity, and thereafter compute the autonomous vehicle's updated position and velocity by integrating information received from the motion-sensing devices. In one example, a GPS receiver (not shown in FIG. 9) may provide the initial position of the autonomous vehicle 900 (e.g., latitude, longitude, altitude). Thereafter, the autonomous vehicle 900 may use the inertial navigation system 906 to determine its position in relation to the objects on the 3D map. As the autonomous vehicle 900 drives to the destination, updated positional information from the inertial navigation system 906 may continually update the 3D map of the autonomous vehicle's surroundings.

The radar sensors 908 may be mounted on front, rear and/or side sections of the autonomous vehicle 900. The radar sensors 908 may monitor a position of proximately-located vehicles on the road, such as vehicles immediately behind or in front of the autonomous vehicle 900. In addition, ultrasonic sensors 910 may be used to measure a distance to proximately-located objects, such as curbs or other vehicles when the autonomous vehicle 900 is parking. The radar sensors 908 and the ultrasonic sensors 910 may be used when generating and updating the 3D map of the autonomous vehicle's surroundings. For example, the radar sensors 908 and the ultrasonic sensors 910 may detect objects that are located in proximity to the autonomous vehicle 900 and those objects may be included in the 3D map of the autonomous vehicle's surroundings.

The transceiver 912 may allow the autonomous vehicle 900 to communicate with other devices or systems when driving to the destination. For example, the transceiver 912 may communicate with other vehicles on the road using vehicle-to-vehicle (V2V) communication. V2V communication may use dedicated short-range communications (DSRC) and operate in the 5.9 GHz frequency range. The range for V2V communication may be approximately 300 meters. In addition, the transceiver 912 may communicate with computing devices (e.g., mobile phones, tablet computers) that provide instructions to the autonomous vehicle 900 via wireless communication standards, such as Third Generation Partnership Project (3GPP) Long Term Evolution (LTE), Wi-Fi, WiMAX, Bluetooth, etc. The above list of wireless communication standards is non-limiting and is intended to include related wireless communication standards that are forthcoming In one example, the transceiver 912 may enable the autonomous vehicle 900 to receive messages from the computing devices, such as messages requesting a pickup, messages instructing the autonomous vehicle 900 to perform a particular task, etc.

The computing device 914 may receive information collected and/or generated from the LIDAR system 902, the video cameras 904, the inertial navigation system 906, the radar sensors 908, the ultrasonic sensors 910, and the transceiver 912. The computing device 914 may process the information (e.g., the 3D map of the vehicle's surroundings) in real-time and determine whether to modify the autonomous vehicle's current velocity and orientation in response to the sensed environment. The computing device 914 may use the received information in order to provide commands to the autonomous vehicle's actuators, thereby controlling steering, acceleration, braking and throttle of the autonomous vehicle 900. The computing device 914 may perform the tasks of localization, 3D mapping, obstacle avoidance, path planning, etc. multiple times per second until the autonomous vehicle 900 reaches the destination. In addition, the computing device 914 may include a data store that stores various types of information, such as road speed limits, traffic accidents, road construction work, etc. The computing device 914 may receive the information from a server via the transceiver 912. The computing device 914 may use the various types of information received from the server for making intelligent decisions when guiding the autonomous vehicle 900 to the destination,

In one example, the computing device 914 or a portion of the computing device 914 may be in idle mode (e.g., a low power mode or a standby mode) when the autonomous vehicle 900 is shut off For example, the computing device 914 may be in idle mode when the autonomous vehicle 900 is parked in a parking space. The computing device 914 may periodically check for messages that are received when the computing device 914 is in idle mode. For example, the computing device 914 may periodically check for messages received from a mobile device. The computing device 914 may transition from idle mode into an on mode upon receiving a message that instructs the autonomous vehicle 900 to perform a task (e.g., drive to a destination). In one configuration, the computing device 914 or the portion of the computing device 914 may be powered via energy harvesting when in idle mode. For example, the computing device 914 may derive energy from external sources in order to receive messages from the device. The external sources may include, but is not limited to, solar power, battery power, thermal power, wind energy, and kinetic energy.

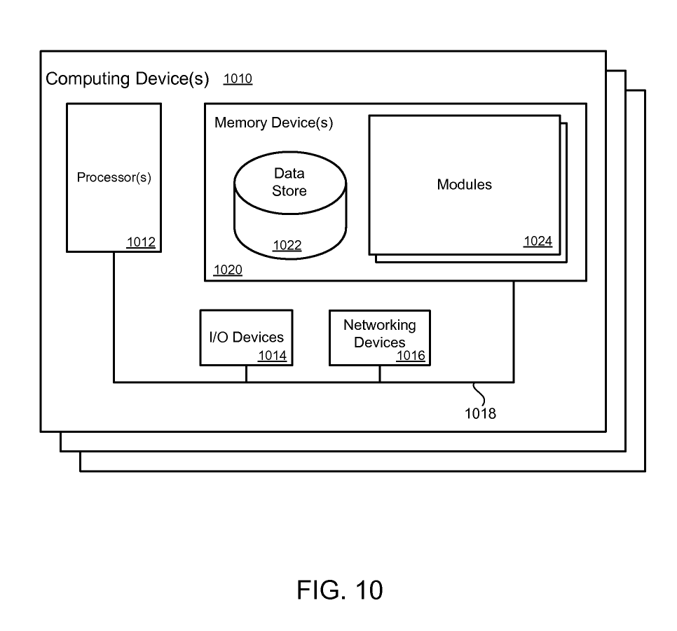

FIG. 10 illustrates a computing device 1010 on which modules of this technology may execute. A computing device 1010 is illustrated on which a high level example of the technology may be executed. The computing device 1010 may include one or more processors 1012 that are in communication with memory devices 1020. The computing device may include a local communication interface 1018 for the components in the computing device. For example, the local communication interface may be a local data bus and/or any related address or control busses as may be desired.

The memory device 1020 may contain modules 1024 that are executable by the processor(s) 1012 and data for the modules 1024. The modules 1024 may execute the functions described earlier. A data store 1022 may also be located in the memory device 1020 for storing data related to the modules 1024 and other applications along with an operating system that is executable by the processor(s) 1012.

Other applications may also be stored in the memory device 1020 and may be executable by the processor(s) 1012. Components or modules discussed in this description that may be implemented in the form of software using high programming level languages that are compiled, interpreted or executed using a hybrid of the methods.

The computing device may also have access to I/O (input/output) devices 1014 that are usable by the computing devices. An example of an I/O device is a display screen that is available to display output from the computing devices. Other known I/O device may be used with the computing device as desired. Networking devices 1016 and similar communication devices may be included in the computing device. The networking devices 1016 may be wired or wireless networking devices that connect to the internet, a LAN, WAN, or other computing network.

The components or modules that are shown as being stored in the memory device 1020 may be executed by the processor 1012. The term “executable” may mean a program file that is in a form that may be executed by a processor 1012. For example, a program in a higher level language may be compiled into machine code in a format that may be loaded into a random access portion of the memory device 1020 and executed by the processor 1012, or source code may be loaded by another executable program and interpreted to generate instructions in a random access portion of the memory to be executed by a processor. The executable program may be stored in any portion or component of the memory device 1020. For example, the memory device 1020 may be random access memory (RAM), read only memory (ROM), flash memory, a solid state drive, memory card, a hard drive, optical disk, floppy disk, magnetic tape, or any other memory components.

The processor 1012 may represent multiple processors and the memory 1020 may represent multiple memory units that operate in parallel to the processing circuits. This may provide parallel processing channels for the processes and data in the system. The local interface 1018 may be used as a network to facilitate communication between any of the multiple processors and multiple memories. The local interface 1018 may use additional systems designed for coordinating communication such as load balancing, bulk data transfer, and similar systems.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

As used herein, the term “processor” can include general purpose processors, specialized processors such as VLSI, FPGAs, and other types of specialized processors, as well as base band processors used in transceivers to send, receive, and process wireless communications.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Reference was made to the examples illustrated in the drawings, and specific language was used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure, are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

What is claimed is:

1. At least one non-transitory machine readable storage medium having instructions embodied thereon for providing advertisements to an autonomous vehicle, the instructions when executed perform the following:
receiving, using one or more processors, a starting location and a destination for the autonomous vehicle;
generating, using the one or more processors, a route for the autonomous vehicle to drive from the starting location to the destination, wherein the route is in proximity to one or more business entities that provide a product or service of interest to a passenger within the autonomous vehicle;
sending, using the one or more processors, the route to the autonomous vehicle, wherein the autonomous vehicle is configured to provide commands to drive the autonomous vehicle to the destination in accordance with the route; and
transmitting, using the one or more processors, one or more advertisements for the one or more business entities in proximity to the route when the autonomous vehicle is within a defined distance from the business entities when driving on the route to the destination.

2. The at least one non-transitory machine readable storage medium of claim 1, further comprising instructions which when executed by the one or more processors performs the following: generating the route to be in proximity to the business entities using an interest profile of the passenger within the autonomous vehicle.

3. The at least one non-transitory machine readable storage medium of claim 2, wherein the interest profile includes at least one of: demographical information, a browsing history, a search history or a purchase history.

4. The at least one non-transitory machine readable storage medium of claim 1, wherein the advertisements for the business entities are selected based on a current time of day.

5. The at least one non-transitory machine readable storage medium of claim 1, wherein:
the route is within a predefined threshold of a shortest-distance route between the starting location and the destination; or
the route is within a predefined threshold of a shortest-time route between the starting location and the destination.

6. The at least one non-transitory machine readable storage medium of claim 1, wherein the autonomous vehicle is included in a fleet of autonomous vehicles that provide taxi services to customers.

7. The at least one non-transitory machine readable storage medium of claim 1, further comprising instructions which when executed by the one or more processors performs the following:
detecting that the autonomous vehicle is within the defined distance from a business entity when driving on the route to the destination; and
transmitting the advertisement for the business entity to the autonomous vehicle.

8. The at least one non-transitory machine readable storage medium of claim 1, further comprising instructions which when executed by the one or more processors performs the following:
receiving an indication when the passenger within the autonomous vehicle selects an advertisement provided to the autonomous vehicle;
selecting additional advertisements for business entities in proximity to the route that are related to the advertisement selected by the passenger; and
transmitting the additional advertisements when the autonomous vehicle is driving on the route to the destination.

9. The at least one non-transitory machine readable storage medium of claim 1, further comprising instructions which when executed by the one or more processors performs the following:
receiving a message when the passenger within the autonomous vehicle provides commands to redirect the autonomous vehicle to a business entity associated with an advertisement transmitted to the autonomous vehicle;
generating a modified route for the autonomous vehicle to drive to the business entity; and
sending the modified route to the autonomous vehicle, wherein the autonomous vehicle is configured to provide commands to drive the autonomous vehicle to the business entity in accordance with the modified route.

10. The at least one non-transitory machine readable storage medium of claim 1, further comprising instructions which when executed by the one or more processors performs the following:
receiving a current location of the autonomous vehicle;
selecting advertisements for business entities that are located in proximity to the current location of the autonomous vehicle; and
transmitting the advertisements to the autonomous vehicle.

11. An autonomous vehicle operable to receive advertisements, the autonomous vehicle comprising:
a processor;
a memory device including a data store to store a plurality of data and instructions that, when executed by the processor, cause the processor to:
select a route for traveling from a current location associated with the autonomous vehicle to a destination;
send the route to a server, wherein the server identifies at least one business entity in proximity to the route that provides a product or service of interest to a passenger within the autonomous vehicle;
provide commands to drive the autonomous vehicle to the destination according to the route; and
receive at least one advertisement associated with the business entity from the server, the advertisement being received when the autonomous vehicle is in proximity to the business entity when driving on the route to the destination.

12. The autonomous vehicle of claim 11, wherein the plurality of data and instructions, when executed by the processor, cause the processor to: display the advertisement on a display screen within the autonomous vehicle.

13. The autonomous vehicle of claim 11, wherein the plurality of data and instructions, when executed by the processor, cause the processor to:
receive instructions from the passenger within the autonomous vehicle to stop at the business entity after receiving the advertisement for the business entity;
calculate a modified route for redirecting the autonomous vehicle to the business entity before driving to the destination; and
provide commands to drive the autonomous vehicle to the destination in accordance with the modified route.

14. The autonomous vehicle of claim 11, wherein the advertisement is received for the business entity when the autonomous vehicle is at a predetermined distance from the business entity when driving on the route to the destination.

15. The autonomous vehicle of claim 11, wherein the advertisement is for at least one of: a product, a service, a deal, a promotion or a coupon.

16. The autonomous vehicle of claim 11, wherein the advertisement received from the server corresponds to an interest profile of the passenger within the autonomous vehicle, wherein the interest profile includes at least one of: demographical information, a browsing history, a search history or a purchase history.

17. A system for providing advertisements to an autonomous vehicle, the system comprising:
a processor;
a memory device including a data store to store a plurality of data and instructions that, when executed by the processor, cause the processor to:
receive a starting location and a destination for the autonomous vehicle;
identify a set of candidate routes for the autonomous vehicle to drive from the starting location to the destination, wherein each candidate route is in proximity to a business entity of interest to a passenger in the autonomous vehicle;
select a route from the set of candidate routes based on a bidding process between business entities in proximity to the candidate routes;
send the route to the autonomous vehicle, wherein the autonomous vehicle is configured to provide commands to drive the autonomous vehicle to the destination according to the route; and
transmit an advertisement for the business entity that wins the bidding process when the autonomous vehicle is approaching the business entity when driving on the route to the destination.

18. The system of claim 17, wherein the business entity provides at least one of a product, a service, a deal, a promotion or a coupon of interest to the passenger within the autonomous vehicle.

19. The system of claim 17, wherein the route is within a predefined threshold of a shortest-distance route or a shortest-time route between the starting location and the destination.

20. The system of claim 17, wherein a distance or driving time between the starting location and the destination for each of the candidate routes is within a defined range.
